(19) United States
(12) Patent Application Publication
(10) Pub. No.: US 2007/0143495 A1
(43) Pub. Date: Jun. 21, 2007

(54) Personal messaging systems

(76) Inventor: Shai Porat, Benaya (IL)

Correspondence Address: DANIEL J SWIRSKY, 55 REUVEN ST., BEIT SHEMESH, 99544, IL

(21) Appl. No.: 10/582,092

(22) PCT Filed: Dec. 7, 2004
(86) PCT No.: PCT/IL04/01113

§ 371 Date: Jun. 8, 2006

Related U.S. Application Data
(60) Provisional application No. 60/481,749, filed on Dec. 8, 2003.

(51) Int. Cl. G06F 15/173

(52) U.S. Cl. 709/238

(57) ABSTRACT

A personal messaging system includes a portable device (100) for recording and transmitting a voice message to the server (106) per FIG. 1. The server is operative to receive the voice message, extract the identity of a recipient from a predefined portion of the voice message, look up the recipient identity in a database to determine the recipients destination address.

### CROSS REFERENCES TO RELATED APPLICATIONS

The present application claims priority from Provisional U.S. Patent Application Ser. No. 60/481,749, filed on Dec. 8, 2003, and incorporated herein by reference in its entirety.

### FIELD OF THE INVENTION

The present invention relates generally to electronic messaging.

### BACKGROUND OF THE INVENTION

Messaging is a common term used for the transfer of messages, such as voice, text, video, and data, from one location (“sender”) to another (“receiver”) via a communications network, using various devices, services and technologies. Typical examples are numeric or alphanumeric paging, and short messages (SMS) delivered to wireless devices.

One problem with conventional messaging systems is usability. The sender has to go through several steps in order to type or record a message and to provide the destination. When using a mobile device with limited display capabilities and a small keyboard, this is even more difficult. Another problem is that the sender's ability to send a message depends on the receiver's ability to receive a message. This requires the sender to be familiar with the receiver's messaging system.

Some messaging systems and technologies, such as Unified Messaging and Instant Messaging, are designed to overcome some of these problems, but they are very limited when used with mobile devices.

### SUMMARY OF THE INVENTION

The present invention discloses a novel personal messaging system that is intuitive and easy to use.

In one aspect of the present invention a personal messaging system is provided including a portable device for recording and transmitting a voice message, and a server operative to receive the voice message, extract the identity of a recipient from a predefined portion of the voice message, look up the recipient identity in a database associated with the sender of the message in which at least one recipient identity is associated with at least one destination address, compose an outgoing message based on the voice message, and transmit the outgoing message to at least one destination address associated with the recipient identity in the database.

In another aspect of the present invention the portable device is adapted for wireless communication with a wireless network operator.

In another aspect of the present invention the wireless network operator is a cellular telephone operator operative to enable data transmission between the portable device and the server.

In another aspect of the present invention the portable device is incorporated into any of a mobile telephone, a pager, a portable computer, and a navigation device.

In another aspect of the present invention the system further includes a receiver operative to receive the outgoing message from the server.

In another aspect of the present invention the receiver is any of an e-mail client, a voice mailbox, an SMS-capable device, a pager, a fax machine, a telephone, a mobile telephone.

In another aspect of the present invention the predefined portion is either of a predefined beginning and a predefined end of the voice message.

In another aspect of the present invention the server is operative to send a confirmation message to the portable device confirming that the outgoing message was sent to the intended recipient.

In another aspect of the present invention the confirmation message is an alphanumeric message.

In another aspect of the present invention the portable device includes a keypad for activating the portable device, a microphone for recording the voice message, a positioning unit for determining the location of the portable device at the time the voice message is recorded, a processing and control unit for compressing the voice message, a wireless communicator for transmitting the voice message to the server, and a display for displaying a confirmation message sent by the server to the portable device confirming that the outgoing message was sent to the intended recipient.

In another aspect of the present invention the identity of the sender is preprogrammed in the portable device.

In another aspect of the present invention the processing and control unit is operative to combine the sender identity, the sender current location, and the processed voice message into a single message, and convert the single message into a format suitable for data transmission.

In another aspect of the present invention the server includes a message queue for receiving the voice messages, a speech recognition engine, a mapping unit, an outgoing message composer, an incoming message analyzer operative to prepare any of the received message for analysis, extract the identity of the sender and the sender's current location from the received message, employ the speech recognition engine to extract the recipient identity from the predefined portion, employ the mapping unit to translate the sender location into conventional location information, and transfer the received message, the sender and recipient identities, the destination address, the date and time of the creation of the received message, and the sender location information to the outgoing message composer, and a provisioning and personalization unit including the database, where the database includes user-level information, where the outgoing message composer is operative to compose an outgoing message from the information received from the incoming message analyzer in accordance with at least one predefined message handling rule.

In another aspect of the present invention the predefined message handling rule is a user-level message handling rule.

In another aspect of the present invention the predefined message handling rule is a system-level message handling rule.

In another aspect of the present invention the system further includes a dispatcher for sending the outgoing message to a receiver at the destination address.

In another aspect of the present invention the outgoing message is any of text, voice, and data.

In another aspect of the present invention the user-level information includes a personal address book associated with the sender including any of a) a list of recipients along with either of a telephone address and a network address to which messages are to be sent, b) voice samples of recipient names for use with the speech recognition engine to identify the recipients, c) a handling rule for messages, d) a personal phone number, and e) a credit card number.

In another aspect of the present invention the destination address is either of a telephone number and a network address.

In another aspect of the present invention a personal messaging method is provided including receiving a voice message, extracting the identity of a recipient from a predefined portion of the voice message, looking up the recipient identity in a database associated with the sender of the message in which at least one recipient identity is associated with at least one destination address, composing an outgoing message based on the voice message, and transmitting the outgoing message to at least one destination address associated with the recipient identity in the database.

In another aspect of the present invention the extracting step includes extracting the predefined portion from either of a predefined beginning and a predefined end of the voice message.

In another aspect of the present invention the method further includes sending a confirmation message to the sender confining that the outgoing message was sent to the intended recipient.

In another aspect of the present invention the method further includes determining the location of the sender at the time the voice message is recorded, compressing the voice message, and displaying a confirmation message confirming that the outgoing message was sent to the intended recipient.

In another aspect of the present invention the method further includes determining the identity of the sender.

In another aspect of the present invention the method further includes combining the sender identity, the sender current location, and the processed voice message into a single message, and converting the single message into a format suitable for data transmission.

In another aspect of the present invention the method further includes prepare the received message for analysis, extracting the identity of the sender and the sender's current location from the received message, employing a speech recognition engine to extract the recipient identity from the predefined portion, translating the sender location into conventional location information, and composing an outgoing message from the message, identity, and location information in accordance with at least one predefined message handling rule.

### BRIEF DESCRIPTION OF THE DRAWINGS

The present invention will be understood and appreciated more fully from the following detailed description taken in conjunction with the appended drawings in which:

FIG. 1 is a simplified block diagram of a personal messaging system, constructed and operative in accordance with a preferred embodiment of the present invention;

FIG. 2 is a simplified block diagram of portable device 100 of FIG. 1, constructed and operative in accordance with a preferred embodiment of the present invention;

FIG. 3, which is a simplified block diagram of server 106 of FIG. 1, constructed and operative in accordance with a preferred embodiment of the present invention; and

FIG. 4 is a simplified flowchart illustration of an exemplary method of operation of the system of FIGS. 1-3, operative in accordance with a preferred embodiment of the present invention.

### DETAILED DESCRIPTION OF PREFERRED EMBODIMENTS

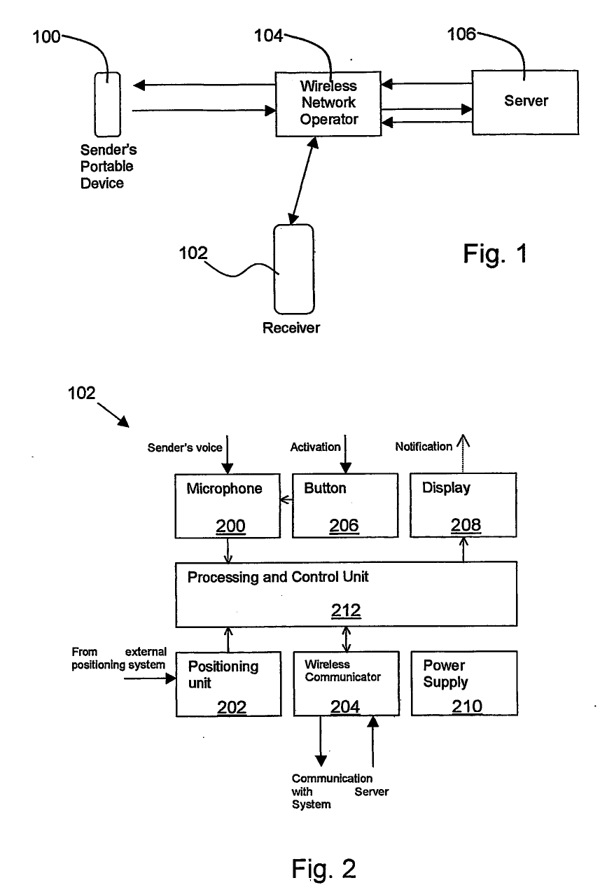

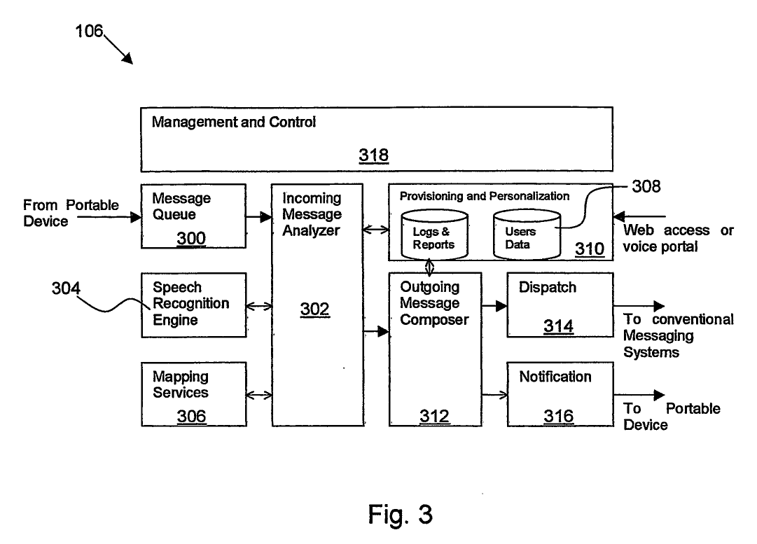

Reference is now made to FIG. 1, which is a simplified block diagram of a personal messaging system, constructed and operative in accordance with a preferred embodiment of the present invention. In the system of FIG. 1, a portable device 100 is shown, such as may be used by a sender of a message to a receiver 102, where portable device 100 is preferably an electronic device adapted for wireless communication with a wireless network operator 104, such as a cellular telephone operator, which enables data transmission between portable device 100 and a server 106. The functionality of portable device 100 as described herein may be incorporated into other portable communicators, such as mobile telephones, pagers, portable computers, and navigation devices. Receiver 102 as described herein may be any message receiver, such as an e-mail client, a voice mailbox, an SMS-capable device, a pager, a fax machine, a telephone, a mobile telephone, or another device capable of receiving messages. Server 106 is preferably provided, in wired or wireless communication with wireless network operator 104, for analyzing messages sent by a sender using portable device 100. Server 106 receives a message sent from portable device 100 via wireless network operator 104, preferably together with information that may be used to determine the identity of the sender and the sender's current location, such as may be provided by portable device 100, and the identity of a recipient, such as may be associated with receiver 102 and which may be voice-input into portable device 100, such as at the beginning or end of the message. Server 106 then dispatches the message to receiver 102 via wireless network operator 104, and preferably sends a message, such as an alphanumeric message, to portable device 100 at or about the same time confirming that the message was sent to receiver 102. Portable device 100 is described in greater detail hereinbelow with reference to FIG. 2, while server 106 is described in greater detail hereinbelow with reference to FIG. 3.

Reference is now made to FIG. 2, which is a simplified block diagram of portable device 100 of FIG. 1, constructed and operative in accordance with a preferred embodiment of the present invention. Portable device 100 of FIG. 2 is preferably self-powered and preferably includes a microphone 200, a positioning unit 202, a wireless communicator 204, a keypad having one or more buttons 206, a display 208, such as an alphanumeric display, and a power supply 210, all of which are preferably controlled by a processing and control unit 212 which may include a memory (not shown). Microphone 200 may be activated when the sender presses button 206 that is designated for this purpose, through which the sender may input a voice message. To complete the message, the user may release the button. The voice message may be stored and processed by the processing and control unit 212, which may compress the voice message using conventional techniques. Positioning unit 202 preferably provides the current location of portable device 100 to processing and control unit 212, such as by employing Global Positioning System (GPS) apparatus and techniques. Processing and Control unit preferably combines the sender's identity, which may be preprogrammed into processing and control unit 212 memory, the sender's current location, and the processed voice message into a single message, and converts the message using conventional techniques into a format suitable for data transmission to wireless network operator 104 (FIG. 1), which then routes the message to server 106. Processing and control unit 212 preferably transmits the message using wireless communicator 204, which may employ standard wireless data modem technology, such as GPRS or CDMA. Wireless communicator 204 may also receive data from server 106 via wireless network operator 104, such as for analysis by processing and control unit 212 and/or display on display 208. Display 208 may also be used for displaying error messages and other indications, such as the current time and/or date, a battery power indicator, and a network coverage or signal strength indicator.

Reference is now made to FIG. 3, which is a simplified block diagram of server 106 of FIG. 1, constructed and operative in accordance with a preferred embodiment of the present invention. Server 106 preferably includes a message queue 300 into which messages sent from portable device 100 and routed to server 106 by wireless network operator 104 may be received before they are forwarded to an incoming message analyzer 302 for processing. Incoming message analyzer 302 preferably prepares the incoming message for analysis, such as by decompressing and/or decoding the message if required, and extract the sender's identity and current location. Incoming message analyzer 302 may extract a predefined portion of the message, such as the first two seconds of the recorded voice message, and determine the identity of the intended recipient of the message using a speech recognition engine 304 on the extracted portion. Incoming message analyzer 302 may also employ a mapping unit 306 to translate the current location of the sender as received from the portable device 100 into conventional location information, such as street, street number, and city information using conventional techniques. This information may then be provided when the message is routed to receiver 102, as is described hereinbelow.

Server 106 also preferably includes a provisioning and personalization unit 308 including user data 310, which may have been provided previously by the sender, and which may include a database of user-level information such as a personal address book associated with a sender including a list of recipients along with their telephone addresses and/or network addresses to which messages are to be sent, voice samples of recipient names as may be required by speech recognition engine 304 to identify recipients, handling rules for messages and other service preferences, personal phone numbers, personal accounts information, credit card numbers, etc. Once incoming message analyzer 302 identifies the sender and the recipient of a message it preferably consults user data 310 to determine the identity of the receiver 102 associated with the recipient as known to server 106 and/or user data 310, such as receiver 102's destination address, which may be a telephone number or network address.

Incoming message analyzer 302 preferably transfers the message, the sender and recipient identities, the identity of receiver 102 to which the message is destined, the date and time of the creation of the message which may be determined by portable device 100 or server 106, and the sender's location information to an outgoing message composer 312 which preferably composes an outgoing message from the information in accordance with predefined user-level and/or system-level message handling rules. Examples of such rules may include: where a sender only allows certain recipients to receive its location information, where a sender wants a message to include credit card information when it is sent to a certain recipient, but not when sent to others; and where a sender wants a message to be sent using different methods depending on the time of day and the recipient. Message composer 312 then sends the message to a dispatcher 314 along with destination information. Dispatcher 314 may then send the message to receiver 102, such as via any conventional messaging system as may be employed by network operator 104, which may use the destination information to dispatch the message to the receiver 102 of the intended recipient. The message may be text, voice, data, or a combination thereof according to the message handling rules and based on the analysis of incoming message analyzer 302. Message composer 312 may use conventional text-to-speech methods to generate a voice message which may include sender's information in addition to the original voice message and in accordance with any predefined messaging handling rules that may apply.

The composed message may be dispatched using a conventional data link, such the Internet, to a conventional messaging system gateway for delivery to receiver 102. In a preferred embodiment of this invention the functionality of receiver 102 is preferably incorporated into portable device 100, such as by providing portable device 100 with a speaker and enabling its software to allow a user to both send and receive messages using portable device 100.

A notification of delivery may optionally be sent via a notification unit 314 via wireless network operator 104 to the sender's portable device 100, such as in the form of an alphanumeric message to be displayed on the portable device's display. The notification may include the recipient's name or other information based on the message type and the message handling rules as previously set and stored in user data 310.

The operation of server 106 may be additionally understood by way of the following sample messages and exemplary rules that may be applied to them.

Message #1: “John. I will be 10 minutes late.” In this example, speech recognition engine 304 matches “John” with the sender's pre-recorded voice sample of the recipient's name, as stored in users data 310. The message handling rules for recipient “John” indicate that the original voice message is to be delivered to the recipient's voice mail with the sender's name added to the beginning of the voice message. Thus, the recipient “John” will receive the following voice message in his voice mail box: “Message from Jim Dow. I will be 10 minutes late”.

Message #2: “Mom. I want you to pick me up.” In this example, speech recognition engine 304 matches “Mom” with the sender's pre-recorded voice sample of recipient's name, as stored in users data 310. The message handling rules for recipient “Mom” indicate that the original voice message is to be delivered to two recipients, such as the child's mother and father, along with the location of the sender. The message handling rules may also specify different delivery methods depending on the time of day. In this example, the child's mother will receive a phone call saying: “Message from Julie. I want you to pick me up. Location: 43 Chestnut Road, Boston, Mass”, and the child's father will receive a message to his portable device, including, in text form, “Message from Julie. 10:23 AM. At 43 Chestnut Road, Boston, Mass.”, together with the original recorded message “Mom. I want you to pick me up.”

Message #3: “Help!” In this example, speech recognition engine 304 matches “Help” with the sender's pre-recorded voice sample as stored in users data 310, and associates the message with a recipient and applicable message handling rules. The message handling rules for recipient “Help” indicate that an immediate emergency alert be sent to the nearest emergency station, including the location, full name and identification details of sender. The message may be: “Emergency assistance call from Jane Dow. Female. 5′7″. Long brown hair. 8:45 PM. Waypoint N4222.183 W07101.159”.

Any of the elements shown in FIG. 3 may be controlled by a management and control unit 318 which may include a memory (not shown).

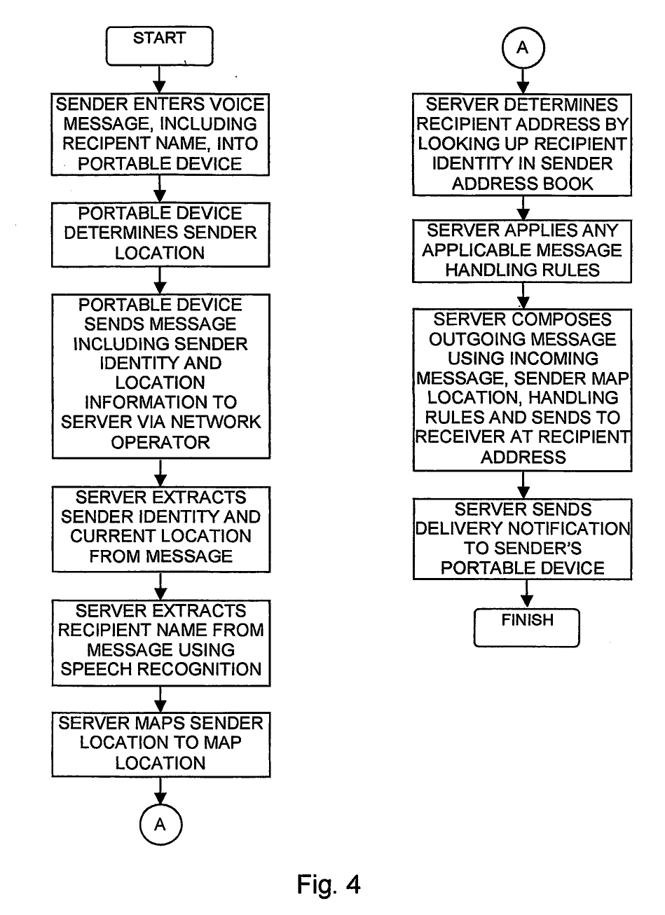

FIG. 4 is a simplified flowchart illustration of an exemplary method of operation of the system of FIGS. 1-3, operative in accordance with a preferred embodiment of the present invention. The method of FIG. 4 may be understood with reference to the description of FIGS. 1-3 hereinabove.

It is appreciated that one or more of the steps of any of the methods described herein may be omitted or carried out in a different order than that shown, without departing from the true spirit and scope of the invention.

While the methods and apparatus disclosed herein may or may not have been described with reference to specific computer hardware or software, it is appreciated that the methods and apparatus described herein may be readily implemented in computer hardware or software using conventional techniques.

While the present invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

What is claimed is:

1. A personal messaging system comprising:
a portable device for recording and transmitting a voice message; and
a server operative to:
receive said voice message;
extract the identity of a recipient from a predefined portion of said voice message;
look up said recipient identity in a database associated with the sender of said message in which at least one recipient identity is associated with at least one destination address;
compose an outgoing message based on said voice message; and
transmit said outgoing message to at least one destination address associated with said recipient identity in said database.

2. A system according to claim 1 wherein said portable device is adapted for wireless communication with a wireless network operator.

3. A system according to claim 2 wherein said wireless network operator is a cellular telephone operator operative to enable data transmission between said portable device and said server.

4. A system according to claim 1 wherein said portable device is incorporated into any of a mobile telephone, a pager, a portable computer, and a navigation device.

5. A system according to claim 1 and further comprising a receiver operative to receive said outgoing message from said server.

6. A system according to claim 5 wherein said receiver is any of an e-mail client, a voice mailbox, an SMS-capable device, a pager, a fax machine, a telephone, a mobile telephone.

7. A system according to claim 1 wherein said predefined portion is either of a predefined beginning and a predefined end of said voice message.

8. A system according to claim 1 wherein said server is operative to send a confirmation message to said portable device confirming that said outgoing message was sent to said intended recipient.

9. A system according to claim 8 wherein said confirmation message is an alphanumeric message.

10. A system according to claim 1 wherein said portable device comprises:
a keypad for activating said portable device;
a microphone for recording said voice message;
a positioning unit for determining the location of said portable device at the time said voice message is recorded;
a processing and control unit for compressing said voice message;
a wireless communicator for transmitting said voice message to said server; and
a display for displaying a confirmation message sent by said server to said portable device confirming that said outgoing message was sent to said intended recipient.

11. A system according to claim 10 wherein the identity of said sender is preprogrammed in said portable device.

12. A system according to claim 11 wherein said processing and control unit is operative to combine said sender identity, said sender current location, and said processed voice message into a single message, and convert said single message into a format suitable for data transmission.

13. A system according to claim 1 wherein said server comprises:
a message queue for receiving said voice messages;
a speech recognition engine;
a mapping unit;
an outgoing message composer;
an incoming message analyzer operative to:
prepare any of said received message for analysis;
extract the identity of said sender and said sender's current location from said received message;
employ said speech recognition engine to extract said recipient identity from said predefined portion;
employ said mapping unit to translate said sender location into conventional location information; and
transfer said received message, said sender and recipient identities, said destination address, the date and time of the creation of said received message, and said sender location information to said outgoing message composer; and
a provisioning and personalization unit including said database, wherein said database includes user-level information,
wherein said outgoing message composer is operative to compose an outgoing message from said information received from said incoming message analyzer in accordance with at least one predefined message handling rule.

14. A system according to claim 13 wherein said predefined message handling rule is a user-level message handling rule.

15. A system according to claim 13 wherein said predefined message handling rule is a system-level message handling rule.

16. A system according to claim 13 and further comprising a dispatcher for sending said outgoing message to a receiver at said destination address.

17. A system according to claim 13 wherein said outgoing message is any of text, voice, and data.

18. A system according to claim 13 wherein said user-level information includes a personal address book associated with said sender including any of a) a list of recipients along with either of a telephone address and a network address to which messages are to be sent, b) voice samples of recipient names for use with said speech recognition engine to identify said recipients, c) a handling rule for messages, d) a personal phone number, and e) a credit card number.

19. A system according to claim 1 wherein said destination address is either of a telephone number and a network address.

20. A personal messaging method comprising:
receiving a voice message;
extracting the identity of a recipient from a predefined portion of said voice message;
looking up said recipient identity in a database associated with the sender of said message in which at least one recipient identity is associated with at least one destination address;
composing an outgoing message based on said voice message; and
transmitting said outgoing message to at least one destination address associated with said recipient identity in said database.

21. A method according to claim 20 wherein said extracting step comprises extracting said predefined portion from either of a predefined beginning and a predefined end of said voice message.

22. A method according to claim 20 and further comprising sending a confirmation message to said sender confirming that said outgoing message was sent to said intended recipient.

23. A method according to claim 20 and further comprising:
determining the location of said sender at the time said voice message is recorded;
compressing said voice message; and
displaying a confirmation message confirming that said outgoing message was sent to said intended recipient.

24. A method according to claim 20 and further comprising determining the identity of said sender.

25. A method according to claim 24 and further comprising combining said sender identity, said sender current location, and said processed voice message into a single message, and converting said single message into a format suitable for data transmission.

26. A method according to claim 20 and further comprising:
prepare said received message for analysis;
extracting the identity of said sender and said sender's current location from said received message;
employing a speech recognition engine to extract said recipient identity from said predefined portion;
translating said sender location into conventional location information; and
composing an outgoing message from said message, identity, and location information in accordance with at least one predefined message handling rule.
